(19) United States
(12) Patent Application Publication
(10) Pub. No.: US 2010/0023815 A1
(43) Pub. Date: Jan. 28, 2010

(54) MANAGING APPARATUS, MANAGING METHOD, MANAGING SYSTEM AND COMPUTER PRODUCT

(75) Inventors: Eiji HASEGAWA, Kawasaki (JP); Hironori Sakakihara, Kawasaki (JP); Fumio Honda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/497,035

(22) Filed: Jul. 2, 2009

(30) Foreign Application Priority Data
Jul. 25, 2008 (JP) 2008-192006

(51) Int. Cl. G06F 11/30; G06F 11/00

(52) U.S. Cl. 714/57; 714/49; 714/E11.179; 714/E11.03

(57) ABSTRACT

An apparatus accepts an injustice (grievance) report containing injustice report source terminal information for identifying a terminal device transmitting the injustice report and injustice content holding terminal information identifying a terminal device holding the content altered from the original content and content identification information for identifying the content; accesses a correspondence relation recording unit recording, in association with content identification information identifying the content, notification destination terminal information identifying a terminal device to which the content holding terminal information is notified, and content holding terminal information notified to the notified terminal device; determines that the injustice report accepted by the injustice report accepting is false and discards the false injustice report, when the injustice report source terminal information contained in the injustice report is not coincident with the notification destination terminal information recorded in the correspondence relation recording unit.

### CROSS-REFERENCE TO RELATED APPLICATIONS

This application claims the benefit of priority from Japanese Patent Application No. 2008-192006 filed on Jul. 25, 2008, which is herein incorporated by reference in its entirety.

### BACKGROUND

1. Field of the Invention

The present invention relates to a managing device connected to a network to which a plurality of terminal devices are connected, a managing method and a computer product for implementing the managing method.

2. Description of the Related Art

A client server model as described below has been generalized as one style of a computer network. In this client server model, roles are shared to an information processing apparatus (server) undertaking specific roles concentrically and information processing apparatuses (clients) operated by users, and the server and each client are mutually connected to each other through a network.

According to this model, the processing is executed in such a style that a client transmits “request” to the server and then the server returns “reply” to the client.

Recently, a P2P (Peer to Peer) model which is architected not to require any server has become widespread in succession to the client server model having a bottle neck problem of the server in connection with propagation of always-connected broadband lines, enhancement of the processing performance of personal computers and increase of the capacities of hard disks, (see US2002/0198930).

In this model, terminal devices participating in a network evenly undertake equivalent or similar roles so that a specific resource is prevented from concentrating to a specific terminal device.

In the P2P model as described above, when a terminal device participating in a network aims to acquire some content, the terminal device obtains the content from any terminal device of plural terminal devices participating in the network.

On the other hand, in the client server model, a client (terminal device) obtains the content from the server.

That is, in the P2P model, the terminal device obtains a content from another terminal device of a user unlike the client server model, and thus it may obtain a content which is altered from the original content. This is because the user of a terminal device which holds a content may alter dishonestly the content stored on the terminal device.

Therefore, there has been known a method of providing a content verifying unit to a terminal device and verifying through the content verifying unit whether a content obtained from another terminal device of a user is a content altered from the original content (see U.S. Pat. No. 5,862,260).

### SUMMARY

A managing apparatus described below is an apparatus operable to access a network to which plural terminal devices are connected.

The managing apparatus includes a content holding information recording unit for recording content holding terminal information to identify a terminal device holding a content from the plural terminal devices.

The managing apparatus includes a request accepting (or receiving) unit for accepting (or receiving) an acquisition request of the content holding terminal information.

The managing apparatus includes a terminal information notifying unit for notifying the content holding terminal information to the terminal device transmitting the acquisition request according to the acquisition request accepted by the request accepting unit.

The managing apparatus includes a correspondence relation recording unit for recording notification destination terminal information for identifying a terminal device to which the content holding terminal information is notified by the terminal information notifying unit, and content holding terminal information notified to the terminal device by the terminal information notifying unit while the notification destination terminal information and the content holding terminal information are associated with each other. The managing apparatus includes an injustice report accepting unit for accepting an injustice report indicating that a content acquired according to the content holding terminal information notified by the terminal information notifying unit is a content altered from an original content, wherein the injustice report contains injustice report source terminal information for identifying a terminal device transmitting the injustice report and injustice content holding terminal information for identifying a terminal device holding the content altered from the original content.

The managing apparatus includes an injustice report verifying unit for determining that the injustice report accepted by the injustice report accepting unit is a false injustice report and discarding the injustice report accepted by the injustice report accepting unit when the injustice report source terminal information contained in the injustice report is not coincident with the notification destination terminal information recorded in the correspondence relation recording unit, or when the injustice report source terminal information contained in the injustice report is coincident with the notification destination terminal information recorded in the correspondence relation recording unit, however, injustice content holding terminal information contained in the injustice report is not coincident with the content holding terminal information which is recorded in association with the notification destination terminal information in the correspondence relation recording unit.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates the schematic construction of a P2P system according to a first embodiment of the present invention;

FIG. 2 illustrates the schematic construction of a terminal device;

FIG. 3 illustrates an example of content holding terminal information recorded in a content holding information recording unit;

FIG. 4 illustrates an example of content holding terminal information recorded in a content holding information recording unit after a terminal information notifying unit rewrites the content of the content holding information recording unit;

FIG. 5 illustrates an example of corresponding relationship recorded in a correspondence relation recording unit;

FIG. 6 illustrates an example of a hash value recorded in a hash value recording unit;

FIG. 7 illustrates an example of an injustice report recorded in an injustice report recording unit;

FIG. 8 illustrates an example of a content holding terminal information recorded in a content holding information recording unit after a terminal information deleting unit deletes the content holding terminal information;

FIG. 9 illustrates an example of the operation of a P2P system when a terminal device transmits an acquisition request to a managing device;

FIG. 10 illustrates an example of the operation of the P2P system when the terminal device receives the content holding terminal information;

FIG. 11 illustrates an example of the operation of the P2P system when the managing device accepts an injustice report from the terminal device;

FIG. 12 illustrates the schematic construction of a P2P system according to a second embodiment of the present invention;

FIG. 13 illustrates an example of the data structure of injustice terminal information generated by an injustice terminal information generating unit;

FIG. 14 illustrates the schematic construction of a P2P system according to a modification;

FIG. 15 illustrates an example of the operation of the P2P system when the managing device generates injustice terminal information;

FIG. 16 illustrates an example of the operation of the P2P system when the terminal device transmits an acquisition request to the managing device;

FIG. 17 illustrates the schematic construction of a P2P system according to a third embodiment of the present invention;

FIG. 18 illustrates the schematic construction of a terminal device; and

FIG. 19 illustrates an example of the operation of the P2P system when a terminal device aiming at the connection to a network transmits a network-connection request to a terminal device connected to the network.

### DETAILED DESCRIPTION OF THE EMBODIMENTS

In the conventional P2P system, the managing device is not provided with any function of verifying whether an injustice (i.e., a grievance or complaint) report accepted from a terminal device is a false injustice report or not. Therefore for example when a false injustice report is accepted from a malignant terminal device, the following disadvantage occurs.

When the false injustice report contains terminal information of a terminal device which holds the same content as the original or target content, the managing device deletes the same content holding terminal information as the terminal information contained in the false injustice report. Accordingly, a content acquisition request is not transmitted from other terminal devices to the terminal device holding the same content as the original content by having been deleted due to the false injustice report. As a result, in some cases, a terminal device which wishes to acquire a content cannot acquire the content due to the false injustice report from the malignant terminal device although a terminal device holding the same content as the original content exists on the P2P system.

The managing device disclosed below determines whether an injustice report accepted from a terminal device is a false injustice report or not, and discards the injustice report accepted from the terminal device when the accepted injustice report is a false injustice report.

According to an embodiment of the present invention, a managing device operable to access a network to which plural terminal devices are connected, has a content holding information recording unit for recording content holding terminal information to identify a terminal device holding a content from the plural terminal devices; a request accepting unit for accepting an acquisition request of the content holding terminal information; a terminal information notifying unit for notifying the content holding terminal information to the terminal device transmitting the acquisition request according to the acquisition request accepted by the request accepting unit; a correspondence relation recording unit for recording notification destination terminal information for identifying a terminal device to which the content holding terminal information is notified by the terminal information notifying unit, and content holding terminal information notified to the terminal device by the terminal information notifying unit while the notification destination terminal information and the content holding terminal information are associated with each other; an injustice report accepting unit for accepting an injustice report indicating that a content acquired according to the content holding terminal information notified by the terminal information notifying unit is a content altered from an original content, the injustice report containing injustice report source terminal information for identifying a terminal device transmitting the injustice report and injustice content holding terminal information for identifying a terminal device holding the content altered from the original content; and an injustice report verifying unit for determining that the injustice report accepted by the injustice report accepting unit is a false injustice report and discarding the injustice report accepted by the injustice report accepting unit when the injustice report source terminal information contained in the injustice report is not coincident with the notification destination terminal information recorded in the correspondence relation recording unit, or when the injustice report source terminal information contained in the injustice report is coincident with the notification destination terminal information recorded in the correspondence relation recording unit, however, injustice content holding terminal information contained in the injustice report is not coincident with the content holding terminal information which is recorded in association with the notification destination terminal information in the correspondence relation recording unit.

A managing method, a program and a communication system which have substantially the same technical idea as the above managing device are embodiments of the present invention.

According to the above construction, the injustice report verifying unit determines that the injustice report accepted by the injustice report accepting unit is a false injustice report when the injustice report source terminal information contained in the injustice report is not coincident with the notification destination terminal information recorded in the correspondence relation recording unit (hereinafter referred to as “case A”), or when the injustice report source terminal information contained in the injustice report is coincident with the notification destination terminal information recorded in the correspondence relation recording unit, however, injustice content holding terminal information contained in the injustice report is not coincident with the content holding terminal information which is recorded in association with the notification destination terminal information in the correspondence relation recording unit (hereinafter referred to as “case B”).

That is, the case A corresponds to a case where the terminal information notifying unit does not notify content holding terminal information to a terminal device, however, it accepts an injustice report from the terminal device. Accordingly, in this case, the injustice report verifying unit determines that the injustice report accepted by the injustice report accepting unit is a false injustice report.

Furthermore, the case B corresponds to a case where the terminal information notifying unit accepts an injustice report from a terminal device notifying content holding terminal information, however, the injustice content holding terminal information contained in the injustice report is not coincident with the content holding terminal information notified to the terminal device.

That is, in this case, the injustice content holding terminal information which cannot be known by the terminal device is contained in the injustice report. Accordingly, in this case, the injustice report verifying unit determines that the injustice report accepted by the injustice report accepting unit is a false injustice report. Accordingly, when the injustice report accepted by the injustice report accepting unit is a false injustice report, the injustice report verifying unit can discard the injustice report.

In the embodiment of the present invention, it is preferable that the injustice report verifying unit is further provided with a terminal information deleting unit for determining that an injustice report accepted by the injustice report accepting unit is a valid (or true) injustice report and recording the injustice report determined as a valid injustice report into the injustice report recording unit when the injustice report source terminal information contained in the injustice report is coincident with the notification destination terminal information recorded in the correspondence relation recording unit and also the injustice content holding terminal information contained in the injustice report is coincident with the content holding terminal information which is recorded in association with the notification destination terminal information in the correspondence relation recording unit, and deleting from the content holding information recording unit the same content holding terminal information as the injustice content holding terminal information contained in the injustice report when the number of injustice reports recorded in the injustice report recording unit is equal to a threshold value or more.

According to the above style (i.e., aspect or mode), a terminal device which wishes to acquire a content can be controlled so that the content is not acquired from a terminal device which holds a content altered from the original content.

Furthermore, according to this style, the terminal information deleting unit deletes the content holding terminal information from the content holding information recording unit when the number of injustice reports is equal to a threshold value or more.

Here, there is considered such a style that the content holding terminal information is deleted from the content holding information recording unit immediately when an injustice report is accepted at least once.

In this style, content holding terminal information is immediately deleted from the content holding information recording unit on the basis of an injustice report from a terminal device which is caused by simple data garble in a network.

However, according to the above style of the embodiment according to this invention, the terminal information deleting unit deletes the content holding terminal information from the content holding information recording unit when the number of injustice reports is equal to a threshold value or more. Therefore, the content holding terminal information can be prevented from being immediately deleted from the content holding information recording unit due to an injustice report from a terminal device which is caused by simple data garble in the network.

As a result, the content holding terminal information can be deleted from the content holding information recording unit on the basis of a more reliable ground.

It is preferable that the embodiment of this invention is further provided with an injustice terminal information generating unit for generating, on the basis of an injustice report recorded in the injustice report recording unit, injustice content holding terminal information contained in the injustice report and injustice terminal information containing one or more of an injustice frequency representing the number of injustice reports recorded in the injustice report recording unit, and a transmission destination determining unit for determining, on the basis of injustice content holding terminal information contained in the injustice terminal information, a terminal device to which the injustice terminal information generated by the injustice terminal information generating unit should be transmitted, and an injustice terminal information transmitting unit for transmitting the injustice terminal information generated by the injustice terminal information generating unit to a terminal device determined by the transmission destination determining unit.

According to the above style, the injustice terminal information transmitting unit transmits the injustice terminal information to the terminal device determined by the transmission destination determining unit, and thus the injustice terminal information is recorded in the terminal device determined by the transmission destination determining unit.

The terminal device is a terminal device which is determined on the basis of the injustice content holding terminal information by the transmission destination determining unit. Therefore, the injustice terminal information generated by the injustice terminal information generating unit can be dispersively recorded in plural terminal devices connected to the network.

It is preferable in the above embodiment that the injustice terminal information generating unit attaches an electronic signature to the generated injustice terminal information by using a secret key of the managing device, and the injustice terminal information transmitting unit transmits the electronic-signature attached injustice terminal information to the terminal device determined by the transmission destination determining unit.

According to the above style, the terminal device receiving the injustice terminal information to which the electronic signature is attached can determine on the basis of the electronic signature whether the managing device is a rightful managing device or not and the injustice terminal information is altered dishonestly or not.

It is preferable that the embodiment of this invention is further provided with a holding destination determining unit for determining a terminal device holding injustice terminal information of a terminal device transmitting a request for acquiring content holding terminal information on the basis of request source terminal information for identifying the terminal device transmitting the acquisition request when the request accepting unit accepts the acquisition request, an injustice terminal information acquiring unit for acquiring the injustice terminal information of the terminal device transmitting the acquisition request from the terminal device determined by the holding destination determining unit, and a request rejecting unit for rejecting the acquisition request accepted by the request accepting unit when the number of injustices contained in the injustice terminal information acquired by the injustice terminal information acquiring unit is equal to a threshold value or more.

According to the above style, such a terminal device as transmits a content altered from an original content many times can be prevented from acquiring any content.

In the embodiment of the present invention, it is preferable that a terminal device in plural terminal devices connected to a network to which the managing device according to the embodiment of the present invention is connected is provided with a request accepting unit for accepting a connection request to the network from a terminal device other than the plural terminal devices connected to the network, a holding determining unit for determining, on the basis of request source terminal information for identifying the terminal device which transmits the connection request, a terminal device holding injustice terminal information of the terminal device transmitting the connection request when the request accepting unit accepts the connection request to the network, an injustice terminal information acquiring unit for achieving the injustice terminal information of the terminal device transmitting the connection request from the terminal device determined by the holding destination determining unit, and a request rejecting unit for rejecting the connection request accepted by the request accepting unit when the number of injustices contained in the injustice terminal information acquired by the injustice terminal information acquiring unit is equal to threshold value or more.

According to this style, with respect to such a terminal device as transmits a content altered from an original content many times, the connection request from the terminal device to the network can be rejected.

In the embodiment of the present invention, it is preferable that a storage device is further connected to the network, and it is preferable that the embodiment of the present invention is further provided with an injustice terminal information generating unit for generating, on the basis of an injustice report recorded in the injustice report recording unit, injustice terminal information containing one or more of injustice content holding terminal information contained in the injustice report and an injustice frequency representing the number of injustice reports recorded in the injustice report recording unit, and an injustice terminal information transmitting unit for transmitting the injustice terminal information generated by the injustice terminal information generating unit to the storage device.

According to this style, the injustice terminal information generated by the injustice terminal information generating unit can be collectively recorded in the storage device connected to the network.

In the embodiment of the present invention, it is preferable that the injustice terminal information generating unit attaches an electronic signature to the generated injustice terminal information by using a secret key of the managing device, and the injustice terminal information transmitting unit transmits the electronic-signature attached injustice terminal information to the storage device.

According to this style, the storage device which receives the electronic-signature attached injustice terminal information can determine on the basis of the electronic signature whether the managing device is a rightful managing device or not, and the injustice terminal information is dishonestly altered or not.

In the embodiment of the present invention, it is preferable that the embodiment of the present invention is further provided with an injustice terminal information acquiring unit for acquiring injustice terminal information of a terminal device transmitting an acquisition request of content holding terminal information from the storage device when the request accepting unit accepts the acquisition request of the content holding terminal information, and a request rejecting unit for rejecting the acquisition request accepted by the request accepting unit when an injustice frequency contained in the injustice terminal information acquired by the injustice terminal information acquiring unit is equal to a threshold value or more.

According to this style, such a terminal device as transmits a content altered from an original content many times can be prevented from acquiring any content.

It is preferable in the embodiment of the present invention that a terminal device of plural terminal devices connected to a network to which the managing device according to the embodiment of the present invention and a storage device are connected is provided with a request accepting unit for accepting a connection request to a network from a terminal device other than the plural terminal devices connected to the network, an injustice terminal information acquiring unit for acquiring, from the storage device, injustice terminal information of the terminal device transmitting the connection request, and a request rejecting unit for rejecting the connection request accepted by the request accepting unit when the injustice frequency contained in the injustice terminal information acquired by the injustice terminal information acquiring unit is equal to a threshold value or more.

According to this style, with respect to a terminal device which transmits a content altered from an original content many times, the connection request from the terminal device to the network can be rejected.

### Embodiment 1

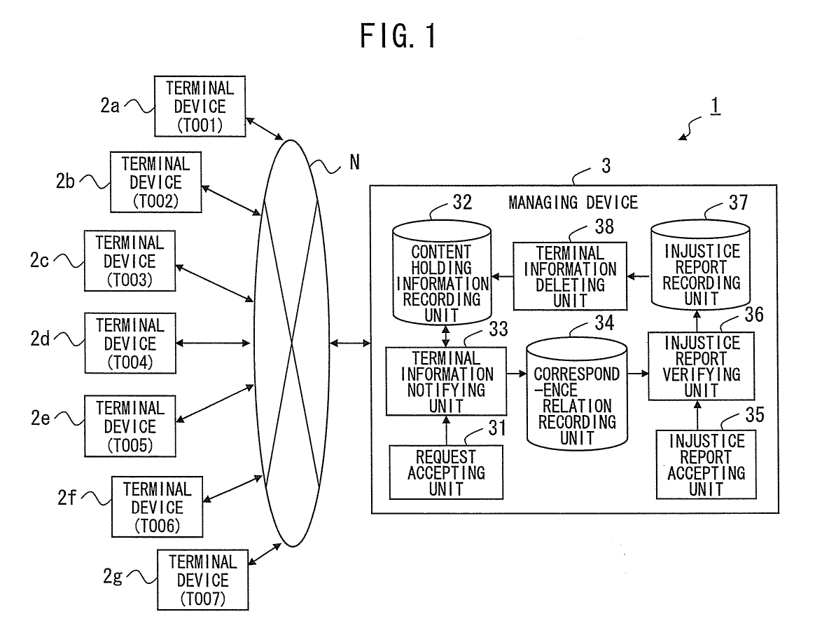

FIG. 1 illustrates the schematic construction of a P2P (Peer to Peer) system 1 according to this embodiment. That is, the P2P system 1 according to this embodiment has terminal devices 2a to 2g, and a managing device 3. In this embodiment, the terminal devices 2a to 2g and the managing device 3 are general-purpose computers. However, the present invention is not limited to this style, and a cellular phone terminal (PDA: Personal Digital Assistant), a cellular phone, a household electrical appliance (for example, television set, printer, digital camera, air conditioner, refrigerator), etc. may be used.

Here, the terminal devices 2a to 2g and the managing device 3 are connected to a network N. The network N is the Internet, for example, and the terminal devices 2a to 2g and the managing device 3 can mutually communicate with one another according to a given protocol such as TCP/IP (Transmission Control Protocol/Internet Protocol), UDP/IP (User Datagram Protocol/Internet Protocol) or the like. In place of the Internet, Ethernet (registered trademark), a home network, wireless LAN or the like may be used as the network N.

In FIG. 1, for the purpose of simplification of description, seven terminal devices 2a to 2g and one managing device 3 are illustrated. However, the number of the terminal devices 2a to 2g and the managing device 3 constituting the P2P system 1 may be set arbitrarily.

Furthermore, various servers (Web server, mail server, homepage server, proxy server, DNS server, DHCP server, etc.) may exist on the P2P system 1.

Here, in this embodiment, terminal information for identifying the terminal device 2a is set to “T001” as illustrated in FIG. 1. Likewise, respective terminal information pieces for identifying the terminal devices 2b to 2g are set to “T002” to “T007”, respectively.

In the case where members having the same function are described, they will be described hereinafter while low-case alphabets are annexed to these members like the terminal device 2a when these members are required to be discriminated from one another. However, they will be described while no low-case alphabet is annexed like the terminal device 2 when they are not particularly required to be discriminated from one another or when they are generically named.

(Construction of Terminal Device 2 for Transmitting Acquisition Request to Managing Device 3)

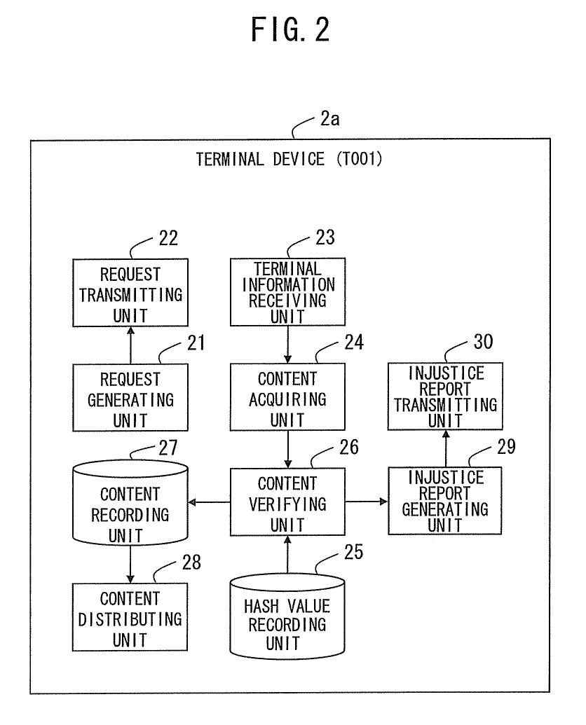

FIG. 2 illustrates the schematic construction of the terminal device 2a according to this embodiment.

The constructions of the terminal devices 2b to 2g are the same as those of the terminal device 2a. Here, the terminal device 2a has a function of transmitting an acquisition request to the managing device 3. Therefore, the terminal device 2a has a request generating unit 21 and a request transmitting unit 22.

The request generating unit 21 generates an acquisition request for content holding terminal information recorded in a content holding information recording unit 32 provided to the managing device 3. Here, the content holding terminal information is terminal information for identifying a terminal device holding a content. The content means documents, still pictures, moving pictures, music or combinations thereof.

Here, in this embodiment, for example, it is assumed that a user of the terminal device 2a wishes to acquire a content A and thus the user of the terminal device 2a instructs the request generating unit 21 to acquire the content A by using an input device (not illustrated). Therefore, the request generating unit 21 according to this embodiment generates a request for acquiring content holding terminal information for identifying a terminal device holding the content A. The request generating unit 21 outputs the generated acquisition request to a request transmitting unit 22.

The request transmitting unit 22 transmits the acquisition request generated in the request generating unit 21 to the managing device 3 through the network N.

(Construction of Managing Device 3 for Notifying Content Holding Terminal Information to Terminal Device 2)

The managing device 3 has a function of notifying the content holding terminal information to the terminal device 2 which transmits the acquisition request. Therefore, as illustrated in FIG. 1, the managing device 3 has a request accepting unit 31, a content holding information recording unit 32, a terminal information notifying unit 33 and a correspondence relation recording unit 34.

The request accepting unit 31 accepts the acquisition request which is transmitted from the terminal device 2 through the network N. In this embodiment, it is assumed that the request accepting unit 31 accepts from the terminal device 2a the acquisition request of the content holding terminal information for identifying the terminal device which holds the content A. The request accepting unit 31 outputs the accepted acquisition request to the terminal information notifying unit 33.

The content holding information recording unit 32 records the content holding terminal information for identifying the terminal device holding the content.

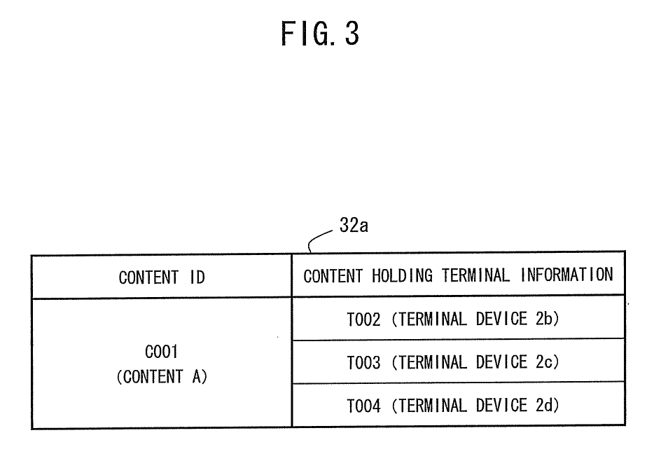

FIG. 3 illustrates an example of the content holding terminal information recorded in the content holding information recording unit 32 according to the embodiment. That is, the content holding information recording unit 32 according to the embodiment records the content holding terminal information as a table 32a. As illustrated in FIG. 3, the content ID “C001” for identifying the content A and the content holding terminal information “T002”, “T003” and “T004” are recorded in the table 32a. That is, the table 32a represents that terminal devices holding the content A are the terminal device 2b, the terminal device 2c and the terminal device 2d on the P2P system 1.

The terminal information notifying unit 33 reads out from the content holding information recording unit 32 any number of content holding terminal information recorded in the content holding information recording unit 32 according to the acquisition request accepted by the request accepting unit 31. That is, the terminal information notifying unit 33 may read out from the content holding information recording unit 32 all the content holding terminal information pieces which are recorded in the content holding information recording unit 32, or may readout from the content holding information recording unit 32 a part (one or a plurality ) of the content holding terminal information pieces recorded in the content holding information recording unit 32.

In this embodiment, the terminal information notifying unit 33 reads out from the content holding information recording unit 32 any number of randomly selected content holding terminal information pieces of the content holding terminal information pieces recorded in the content holding information recording unit 32.

Specifically, it is assumed that the terminal information notifying unit 33 reads out from the content holding information recording unit 32 randomly-selected content holding terminal information pieces “T002” and “T003” of the content holding terminal information pieces “T002”, “T003” and “T004” recorded in the content holding information recording unit 32.

The terminal information notifying unit 33 notifies the read-out content holding terminal information pieces “T002” and “T003” to the terminal device 2a which transmits the acquisition request. Accordingly, the terminal device 2a can grasp that the terminal devices holding the content A are the terminal device 2b and the terminal device 2c on the P2P system 1.

The terminal information notifying unit 33 rewrites the content of the content holding information recording unit 32 so that the terminal information “T001” of the terminal device 2a transmitting the acquisition request becomes the content holding terminal information of the content A.

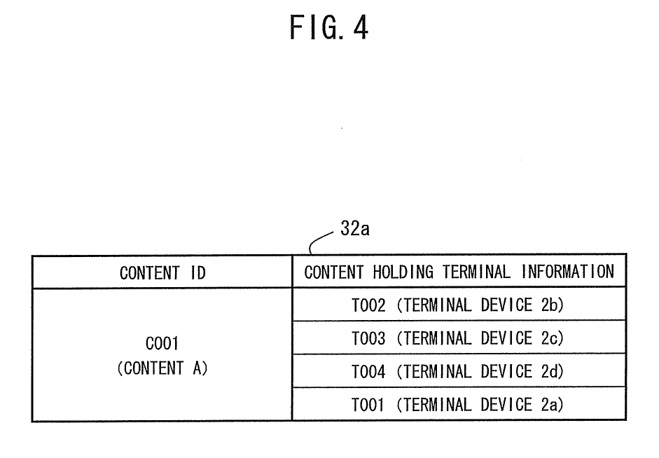

FIG. 4 illustrates an example of the content holding terminal information recorded in the content holding information recording unit 32 after the terminal information notifying unit 33 rewrites the content of the content holding information recording unit 32. That is, in addition to the information of the table 32a illustrated in FIG. 3, the content holding terminal information “T001” is newly recorded in the table 32a illustrated in FIG. 4.

Furthermore, the terminal information notifying unit 33 records notification destination terminal information for identifying the terminal device notifying the content holding terminal information (that is, the terminal device transmitting the acquisition request) and the content holding terminal information notified to the terminal device into the correspondence relation recording unit 34 while associating the notification destination terminal information and the content holding terminal information with each other.

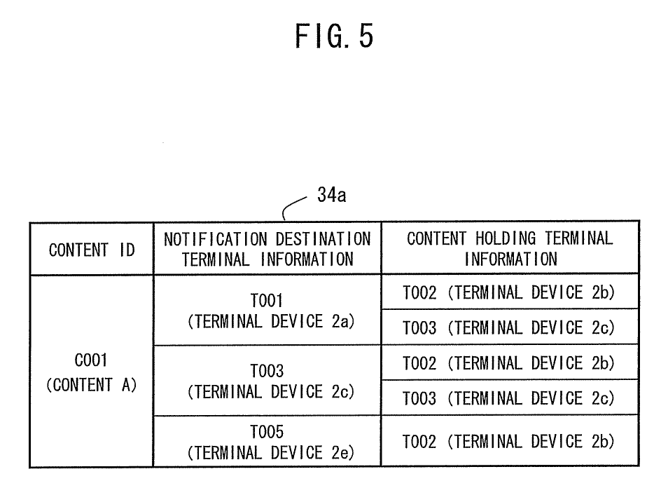

FIG. 5 illustrates an example of the correspondence relation recorded in the correspondence relation recording unit 34 according to this embodiment. That is, the correspondence relation recording unit 34 according to this embodiment records the correspondence relation as a table 34a. As illustrated in FIG. 5, in the table 34a are recorded a content ID, notification destination terminal information and content holding terminal information in association with the notification destination terminal information.

That is, the table 34a represents that the notification destinations to which the content holding terminal information pieces “T002” and “T003” of the content A are notified are the terminal device 2a and the terminal device 2c. Furthermore, the table 34a also represents that the notification destination to which the content holding terminal information “T002” of the content A is notified is the terminal device 2e.

(Construction of Terminal Device for Acquiring Content According to Content Holding Terminal Information)

The terminal device 2a has a function of acquiring a content from another terminal device according to content holding terminal information notified from the managing device 3.

Therefore, the terminal device 2a further has a terminal information receiving unit 23, a content acquiring unit 24, a hash value recording unit 25, a content verifying unit 26, a content recording unit 27, a content distributing unit 28, an injustice report generating unit 29 and an injustice report transmitting unit 30.

The terminal information receiving unit 23 receives the content holding terminal information which is notified from the managing device 3 through the network N. In this embodiment, the terminal information receiving unit 23 receives the content holding terminal information pieces “T002” and “T003” notified from the managing device 3. The terminal information receiving unit 23 outputs the received content holding terminal information to the content acquiring unit 24.

The content acquiring unit 24 transmits a content distributing request to another terminal device on the basis of the content holding terminal information received by the terminal information receiving unit 23. Here, when the terminal information receiving unit 23 receives plural content holding terminal information pieces, the content acquiring unit 24 transmits the content distributing request to another terminal device on the basis of one content holding terminal information which is selected according to a given rule.

In this embodiment, it is assumed that the content acquiring unit 24 transmits the content distributing request to the terminal device 2b on the basis of the content holding terminal information “T002” selected according to the given rule. Therefore, the content acquiring unit 24 can acquire the content A which is distributed from the terminal device 2b through the network N. The content acquiring unit 24 outputs the acquired content to the content verifying unit 26.

The hash value recording unit 25 records a piece number representing a part (piece) constituting a content, and a hash value of the piece.

In this embodiment, the terminal device 2a acquires a hash value from a reliable terminal device, and records the acquired hash value into the hash value recording unit 25 in association with the piece number in advance. The reliable terminal device is a terminal device which is guaranteed to hold the original content.

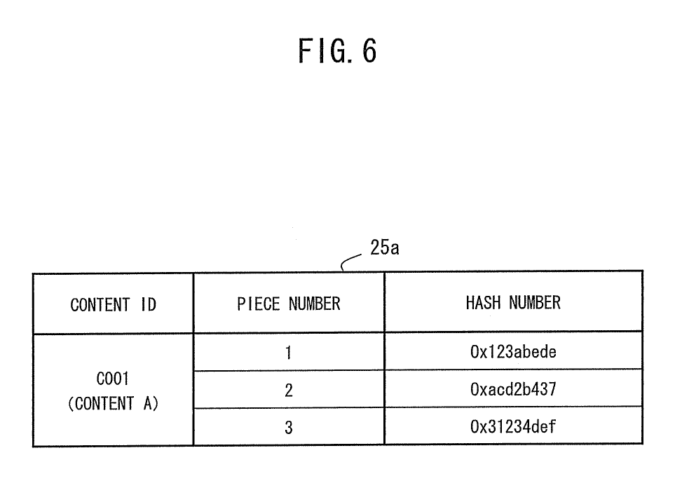

FIG. 6 illustrates an example of the hash value recorded in the hash value recording unit 25 according to this embodiment. That is, the hash value recording unit 25 according to this embodiment records the hash value as a table 25a.

As illustrated in FIG. 6, the content ID “C001”, the piece numbers “1” to “3” and the hash value of each piece are recorded in the table 25a. That is, the content A according to this embodiment comprises a piece represented by the piece number “1”, a piece represented by the piece number “2” and a piece represented by the piece number “3”.

The content verifying unit 26 verifies whether the content acquired by the content acquiring unit 24 is a content which is altered from the original content. In this embodiment, the content verifying unit 26 first divides the content acquired by the content acquiring unit 24 into three pieces. That is, the content verifying unit 26 divides the content acquired by the content acquiring unit 24 into the three pieces so that they are identical to the three pieces represented by the three piece numbers recorded in the hash value recording unit 25.

The content verifying unit 26 calculates the hash value every piece by applying a hash function to each of the divided pieces. The content verifying unit 26 compares the hash value calculated every piece with the hash value recorded in the hash value recording unit 25 to determine whether both the hash values are coincident with each other.

Here, when both the hash values are coincident with each other over all the pieces, the content verifying unit 26 determines that the content acquired by the content acquiring unit 24 is the same content as the original content. In this case, the content verifying unit 26 records the content acquired by the content acquiring unit 24 into the content recording unit 27 together with the calculated hash value.

On the other hand, when both the hash values are not coincident with each other in some piece, the content verifying unit 26 determines that the content acquired by the content acquiring unit 24 is a content altered from the original content. In this case, the content verifying unit 26 discards the content acquired by the content acquiring unit 24.

Furthermore, the content verifying unit 26 instructs the injustice report generating unit 29 to generate an injustice report indicating that the content is altered.

In the foregoing description, the content verifying unit 26 divides the content acquired by the content acquiring unit 24 into the three pieces to calculate the hash value every piece, and compares the hash value calculated every piece with the hash value recorded in the hash value recording unit 25. However, the present invention is not limited to this style. That is, the content verifying unit 26 may calculate the hash value of the content without dividing the content acquired by the content acquiring unit 24 into the respective pieces.

In this case, the hash values of contents are recorded in advance in the hash value recording unit 25, and the content verifying unit 26 compares the calculated hash value of the content with the hash values recorded in the hash value recording unit 25. Furthermore, when the content acquiring unit 24 acquires one or plural pieces in place of the content, the content verifying unit 26 calculates the hash value of the piece without dividing the piece acquired by the content acquiring unit 24.

When the content distributing unit 28 accepts a distribution request of a content from another terminal device through the network N, the content distributing unit 28 reads out a content recorded in the content recording unit 27 according to the distribution request. The content transmitting unit 28 transmits the read-out content to the other terminal device transmitting the distributing request through the network N.

When accepting the distributing request of a piece from another terminal device through the network N, the content distributing unit 28 distributes the piece read out from the content recording unit 27 to the other terminal device transmitting the distributing request.

According to an instruction from the content verifying unit 26, the injustice report generating unit 29 generates an injustice report representing that the content acquired by the content acquiring unit 24 is a content altered from the original content. Here, the injustice report contains injustice report source terminal information for identifying a terminal device which transmits the injustice report, injustice content holding terminal information for identifying a terminal device holding the content altered from the original content, and a content ID for identifying the content. The injustice report generating unit 29 outputs the generated injustice report to the injustice report transmitting unit 30.

The injustice report transmitting unit 30 transmits the injustice report generated by the injustice report generating unit 29 through the network N to the managing device 3.

(Construction of Managing Device 3 for Verifying Injustice Report Transmitted from Terminal Device 2)

The managing device 3 has a function of verifying whether the injustice report transmitted from the terminal device 2 is a false injustice report or not. Therefore, the managing device 3 is further provided with an injustice report accepting unit 35, an injustice report verifying unit 36, an injustice report recording unit 37 and a terminal information deleting unit 38.

The injustice report accepting unit 35 accepts an injustice report transmitted from the terminal device 2 through the network N. The injustice report accepting unit 35 outputs the accepted injustice report to the injustice report verifying unit 36.

The injustice report verifying unit 36 verifies on the basis of the correspondence relation recorded in the correspondence relation recording unit 34 whether the injustice report accepted by the injustice report accepting unit 35 is a false injustice report or not.

Specifically, the injustice report verifying unit 36 determines that the injustice report accepted by the injustice report accepting unit 35 is a false injustice report in the case of (a) or (b) described below.

In this case, the injustice report verifying unit 36 discards the injustice report accepted by the injustice report accepting unit 35.

(a) When the injustice report source terminal information contained in the injustice report and the notification destination terminal information recorded in the correspondence relation recording unit 34 are not coincident, and (b) when the injustice report source terminal information contained in the injustice report and the notification destination terminal information recorded in the correspondence relation recording unit 34 are coincident with each other, however, the injustice content holding terminal information contained in the injustice report is not coincident with the content holding terminal information which is recorded in association with the notification destination terminal information in the correspondence relation recording unit 34.

That is, in the case (a), the terminal information notifying unit 33 accepts an injustice report from the terminal device 2 although it does not notify any content holding terminal information to the terminal device 2. For example, when the table 34a illustrated in FIG. 5 is recorded in the correspondence relation recording unit 34, the terminal information notifying unit 33 accepts an injustice report from the terminal device 2b, 2d, 2f, 2g other than the terminal devices 2a, 2c, 2e. Accordingly, in this case, the injustice report verifying unit 36 determines that the injustice report accepted by the injustice report accepting unit 35 is a false injustice report, and thus discards the injustice report.

Furthermore, in the case (b), the terminal information notifying unit 33 accepts an injustice report from the terminal device 2 which notifies content holding terminal information, however, the injustice content holding terminal information contained in the injustice report is not coincident with the content holding terminal information notified to the terminal device 2. That is, in this case, the injustice content holding terminal information which cannot be known by the terminal device 2 is contained in the injustice report.

For example, when the table 34a illustrated in FIG. 5 is recorded in the correspondence relation recording unit 34, the injustice content holding terminal information contained in the injustice report accepted by the terminal device 2a is any terminal information of “T004” to “T007”. Accordingly, in this case, the injustice report verifying unit 36 also determines that the injustice report accepted by the injustice report accepting unit 35 is a false injustice report, and thus discards the injustice report.

On the other hand, when the injustice report source terminal information contained in the injustice report is coincident with the notification destination terminal information recorded in the correspondence relation recording unit 34 and the injustice content holding terminal information contained in the injustice report is coincident with the content holding terminal information which is recorded in association with the notification destination terminal information in the correspondence relation recording unit 34, the injustice report verifying unit 36 determines that the injustice report accepted by the injustice report accepting unit 35 is a valid injustice report.

For example, this case corresponds to such a case that the injustice content holding terminal information contained in the injustice report accepted from the terminal device 2a is “T002” or “T003” when the table 34a illustrated in FIG. 5 is recorded in the correspondence relation recording unit 34. In this case, the injustice report verifying unit 36 records the injustice report accepted by the injustice report accepting unit 35 into the injustice report recording unit 37 together with the time at which the injustice report is accepted.

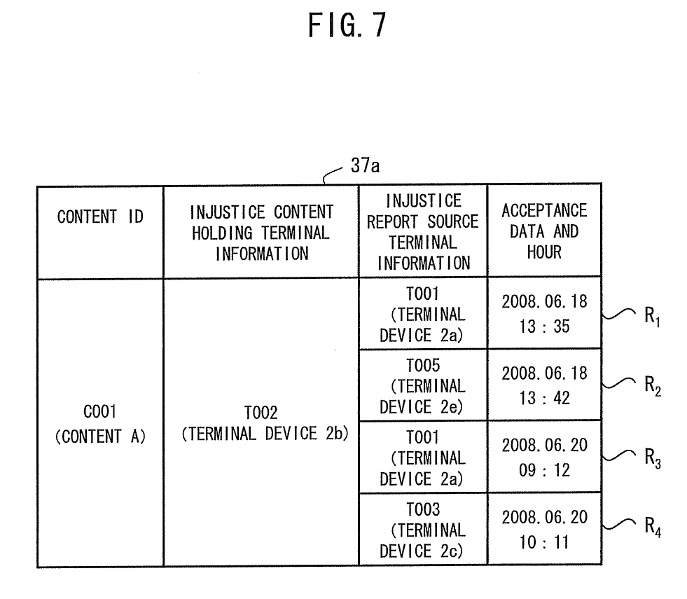

FIG. 7 illustrates an example of the injustice report recorded in the injustice report recording unit 37 according to this embodiment. That is, the injustice report recording unit 37 according to this embodiment records the injustice report as a table 37a.

As illustrated in FIG. 7, the content ID “C001”, the injustice content holding terminal information “T002”, the injustice report source terminal information and the acceptance date and hour at which the injustice report accepting unit 35 accepts the injustice report are recorded in the table 37a. That is, the table 37a is a table indicating injustice reports of the terminal device 2b which holds the altered content A.

Here, a record R1 of the table 37a represents that an injustice report of the terminal device 2b is accepted from the terminal device 2a at 1:35 p.m. on Jun. 18, 2008. Each of records R2 to R4 of the table 37a also represents that an injustice report of the terminal device 2b is accepted from each terminal device at each time. That is, the four records R1 to R4 are recorded in the table 37a, and thus the table 37a represents that the injustice report accepting unit 35 accepts the injustice report of the terminal device 2b at four times.

When the number of injustice reports (the number of records) recorded in the injustice report recording unit 37 is equal to a threshold value or more, the terminal information deleting unit 38 deletes the same content holding terminal information as the injustice content holding terminal information contained in the injustice reports from the content holding information recording unit 32. For example, when the number of the injustice reports of the terminal device 2b recorded in the injustice report recording unit 37 increases to the threshold value or more, the terminal information deleting unit 38 deletes the same content holding terminal information “T002” as the injustice content holding terminal information “T002” from the content holding information recording unit 32.

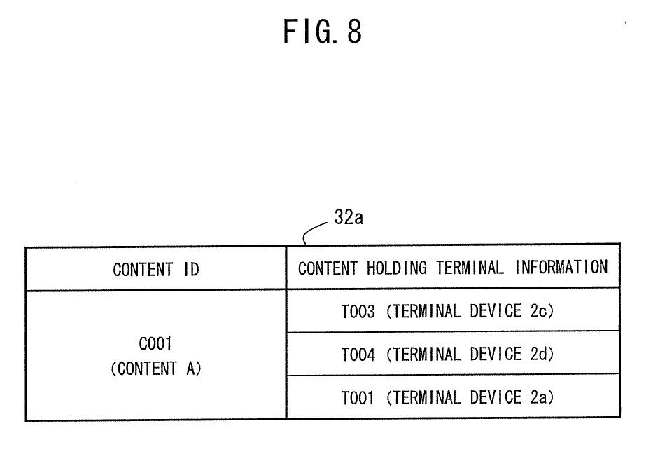

FIG. 8 illustrates an example of the content holding terminal information recorded in the content holding information recording unit 32 after the terminal information deleting unit 38 deletes the content holding terminal information. That is, the content holding terminal information “T002” is deleted from the table 32a illustrated in FIG. 8 as compared with the table 32a illustrated in FIG. 4. Accordingly, the content acquisition request is not transmitted from other terminal devices to the terminal device 2b which holds the content altered from the original content. That is, terminal devices each of which wishes to acquire a content can be controlled so that these terminal devices do not acquire contents from the terminal device 2b holding the content altered from the original content.

The constructions of the terminal device 2 and the managing device 3 are described above, and the members constituting the terminal device 2 and the members constituting the managing device 3 are not necessarily required to be mounted as independent hardware. That is, each of the members of the terminal device 2 according to this embodiment is a functional unit implemented by executing a given program through CPU of the terminal device 2. Furthermore, each of the members of the managing device 3 according to this embodiment is also a functional unit implemented by executing a given program through CPU of the managing device 3. Accordingly, programs for implementing these functional units through a computer or a recording medium in which the programs are recorded is also an embodiment of the present invention. The same is applied to the members of embodiments 2 and 3 described below.

In this embodiment, the terminal device and the managing device are illustrated as being discriminated from each other. However, actually, one terminal device or plural terminal devices of the terminal devices connected to the network N serve as managing devices. For example, by using a well-known DHT (Distributed Hash Table) method, one or plural terminal devices which may serve as managing devices are selected from terminal devices connected to the network N. That is, one terminal device may serve as a content managing device or one terminal deice may serve as plural content managing devices. Furthermore, plural terminal devices may serve as one content managing device.

(Example of Operation of P2P System 1)

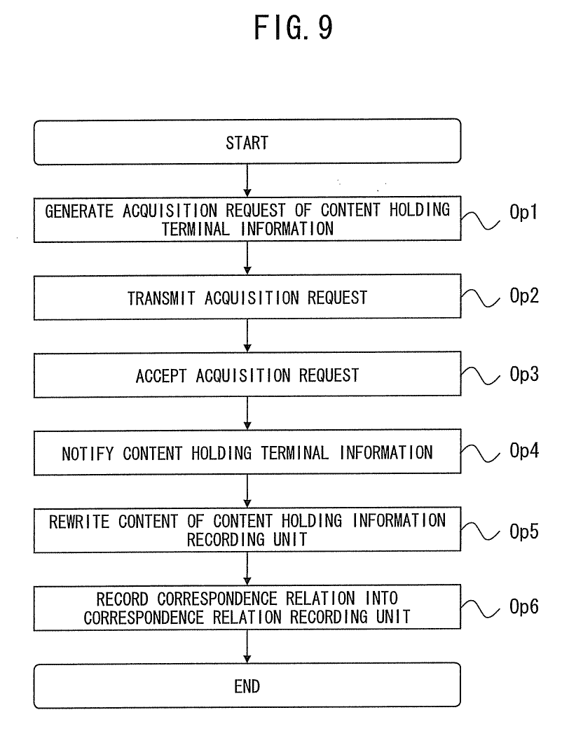

Next, the operation of the thus-constructed P2P system 1 will be described with reference to FIGS. 9 to 11.

FIG. 9 illustrates an example of the operation of the P2P system 1 when the terminal device 2 transmits an acquisition request to the managing device 3.

As illustrated in FIG. 9, the request generating unit 21 of the terminal device 2 generates an acquisition request of content holding terminal information (Op1). The request generating unit 21 transmits the acquisition request generated in Op1 through the network N to the managing device 3 (Op2).

Subsequently, the request accepting unit 31 of the managing device 3 accepts the acquisition request transmitted in Op2 (Op3).

The terminal information notifying unit 33 reads out any number of content holding terminal information pieces recorded in the content holding information recording unit 32 from the content holding information recording unit 32 according to the acquisition request accepted in Op3. The terminal information notifying unit 33 notifies the read-out content holding terminal information to the terminal device 2 transmitting the acquisition request (Op4). Accordingly, the terminal device 2 receiving the content holding terminal information can grasp which terminal device corresponds to the terminal device holding the content on the P2P system 1.

The terminal information notifying unit 33 rewrites the content of the content holding information recording unit 32 so that the terminal information of the terminal device 2 to which the acquisition request is transmitted in Op2 becomes the content holding terminal information (Op5).

Furthermore, the terminal information notifying unit 33 records the notification destination terminal information for identifying the terminal device 2 notifying the content holding terminal information and the content holding terminal information notified to the terminal device 2 in association with each other into the correspondence relation recording unit 34 (Op6).

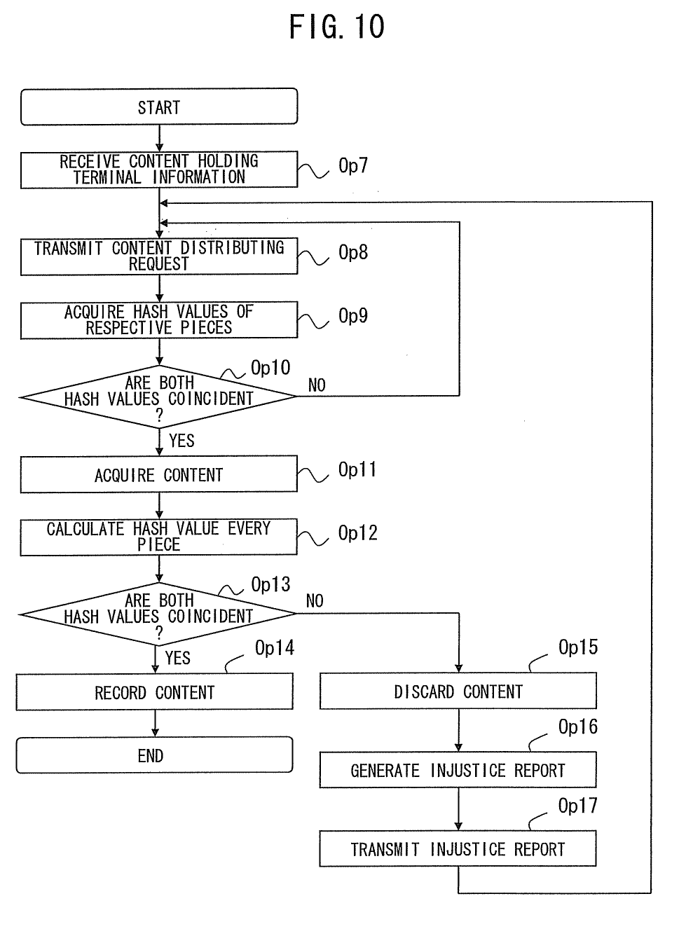

FIG. 10 illustrates an example of the operation of the P2P system 1 when the terminal device 2 receives the content holding terminal information. As illustrated in FIG. 10, the terminal information receiving unit 23 of the terminal device 2 receives the content holding terminal information notified in Op4 of FIG. 9 (Op7) The content acquiring unit 24 transmits the content distributing request to another terminal device on the basis of the content holding terminal information received in Op7 (Op8). The content acquiring unit 24 acquires the hash value of each piece constituting the content from another terminal to which the distributing request is transmitted in Op8 (Op9).

The content verifying unit 26 compares the hash value of each piece acquired in Op9 with the hash value recorded in the hash value recording unit 25 to determine whether both hash values are coincident with each other (Op10).

When the content verifying unit 26 determines that both the hash values are coincident with each other over all the pieces (YES in Op10), the content acquiring unit 24 acquires a content from another terminal device to which the distributing request is transmitted in Op8 (Op11). On the other hand, when both the hash values are not coincident with each other in some piece (NO in Op10), the content verifying unit 26 returns to Op8. In this case, the content acquiring unit 24 transmits the distributing request of the content to another terminal device again on the basis of another content holding terminal information received in Op7.

That is, when the user of a terminal device holding a content alters the content on its own terminal, the following effect is achieved through the processing of Op9 and Op10 described above.

That is, a terminal device which wishes to acquire the content can determine whether the content is altered from the original content without acquiring the content from the terminal device holding the content. That is, the terminal device which wishes to acquire a content may acquire only the hash value of each piece constituting the content from the terminal device holding the content, and thus the traffic of the network N can be suppressed more greatly as compared with the case where the content is acquired.

The content verifying unit 26 calculates the hash value every piece by applying the hash function to each piece constituting the content acquired in Op11 (Op12).

The content verifying unit 26 compares the hash value calculated in Op12 with the hash value recorded in the hash value recording unit 25 to determine whether both the hash values are coincident with each other (Op13).

When it is determined that both the hash values are coincident with each other over all the pieces (YES in Op13), the content verifying unit 26 determines that the content acquired in Op11 is the same content as the original content. In this case, the content verifying unit 26 records the content acquired in Op11 into the content recording unit 27 together with the hash value calculated in Op12 (Op14).

On the other hand, when it is determined that both the hash values are not coincident with each other in some piece (NO in Op13), the content verifying unit 26 determines the content acquired in Op11 as a content altered from the original content. In this case, the content verifying unit 26 discards the content acquired in Op11 (Op15).

That is, when it is determined in Op13 that both the hash values are not coincident with each other although it is determined in Op10 that both the hash values are coincident with each other, the following situation may be considered.

That is, the user of the terminal device holding the content maliciously alters the content in order to make another terminal device acquire the altered content. Accordingly, in this case, the content verifying unit 26 discards the content acquired in Op11.

The injustice report generating unit 29 generates an injustice report indicating that the content acquired in Op11 is a content altered from the original content (Op16). Here, the injustice report contains injustice report source terminal information for identifying the self terminal, injustice content holding terminal information for identifying the terminal device holding the content altered from the original content and content ID for identifying the content.

The injustice report transmitting unit 30 transmits the injustice report generated in Op16 through the network N to the managing device 3 (Op17). Then, the processing returns to Op8, and the content acquiring unit 24 transmits the content distributing request to another terminal device again on the basis of another content holding terminal information received in Op7.

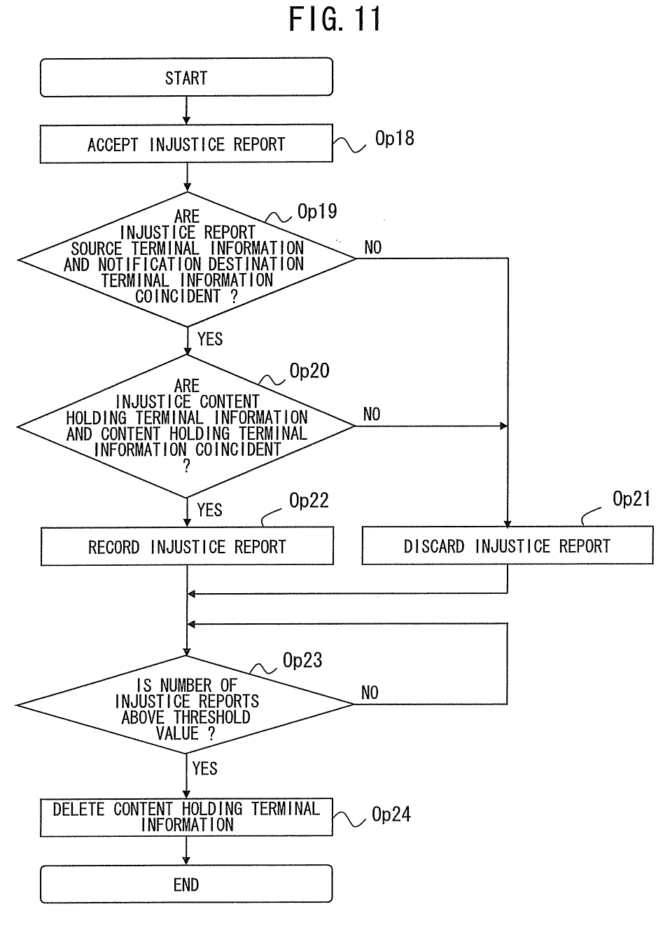

FIG. 11 illustrates an example of the operation of the P2P system 1 when the managing device 3 accepts an injustice report from the terminal device 2. As illustrated in FIG. 11, the injustice report accepting unit 35 of the managing device 3 accepts the injustice report transmitted in Op17 of FIG. 10 (Op18).

The injustice report verifying unit 36 determines whether the injustice report source terminal information contained in the injustice report accepted in Op18 is coincident with the notification destination terminal information recorded in the correspondence relation recording unit 34 (Op19).

The determination processing of Op19 corresponds to the processing of determining whether the injustice report verifying unit 36 is under the case of (a) described above. When it is determined that the injustice report source terminal information and the notification destination terminal information are coincident with each other (YES in Op19), the injustice report verifying unit 36 goes to Op20. On the other hand, when it is determined that the injustice report source terminal information and the notification destination terminal information are not coincident with each other (NO in Op19), the injustice report verifying unit 36 discards the injustice report accepted in Op18 (Op21).

After Op19, the injustice report verifying unit 36 determines whether the injustice content holding terminal information contained in the injustice report accepted in Op18 is coincident with the content holding terminal information which is recorded in association with the notification destination terminal information of Op19 in the correspondence relation recording unit 34 (Op20). The determination processing of Op20 is the processing of determining whether the injustice report verifying unit 36 is under the case of (b).

When it is determined that the injustice content holding terminal information and the content holding terminal information are coincident with each other (YES in Op20), the injustice report verifying unit 36 determines that the injustice report accepted in Op18 is a rightful injustice report. In this case, the injustice report verifying unit 36 records the injustice report accepted in Op18 into the injustice report recording unit 37 together with the acceptance time of the injustice report (Op22).

On the other hand, when it is determined that the injustice content holding terminal information and the content holding terminal information are not coincident with each other (NO in Op20), the injustice report verifying unit 36 determines that the injustice report accepted in Op18 is a false injustice report. In this case, the injustice report verifying u nit 36 discards the injustice report accepted in Op18 (Op21).

Here, the terminal information deleting unit 38 monitors the injustice report recording unit 37 to determine whether the number of injustice reports recorded in the injustice report recording unit 37 is equal to a threshold value or more (Op23).

When it is determined that the number of the injustice reports recorded in the injustice report recording unit for the injustice content holding terminal information contained in the injustice report is equal to the threshold value or more (YES in Op23), the terminal information deleting unit 38 deletes the same content holding terminal information as the injustice content holding terminal information contained in the injustice report from the content holding information recording unit 32 (Op24).

Accordingly, a content acquisition request is prevented from being transmitted from another terminal device to the terminal device which holds a content altered from the original content. That is, a terminal device which wishes to acquire a content can be controlled so that the content is not acquired from the terminal device holding the content altered from the original content.

On the other hand, when it is determined that the number of the injustice reports is not equal to the threshold value or more (NO in Op23), the determination processing of Op23 is repeated.

As described above, according to the managing device 3 of this embodiment, in the case of (a) or (b), the injustice report verifying unit 36 determines that the injustice report accepted by the injustice report accepting unit 35 is a false injustice report. That is, the case (a) corresponds to a case where the terminal information notifying unit 33 accepts an injustice report from a terminal device 2 although it does not notify any content holding terminal information to the terminal device 2. Accordingly, in this case, the injustice report verifying unit 36 determines that the injustice report accepted by the injustice report accepting unit 35 is a false injustice report.

Furthermore, the case (b) correspond to a case where the terminal information notifying unit 33 accepts an injustice report from the terminal device 2 to which the content holding terminal information is notified, but the injustice content holding terminal information contained in the injustice report is not coincident with the content holding terminal information notified to the terminal device 2. That is, the injustice content holding terminal information which cannot be known by the terminal device 2 is contained in the injustice report. Accordingly, in this case, the injustice report verifying unit 36 also determines that the injustice report accepted by the injustice report accepting unit 35 is a false injustice report. Accordingly, when the injustice report accepted by the injustice report accepting unit 35 is a false injustice report, the injustice report verifying unit 36 can discard the injustice report.

### Embodiment 2

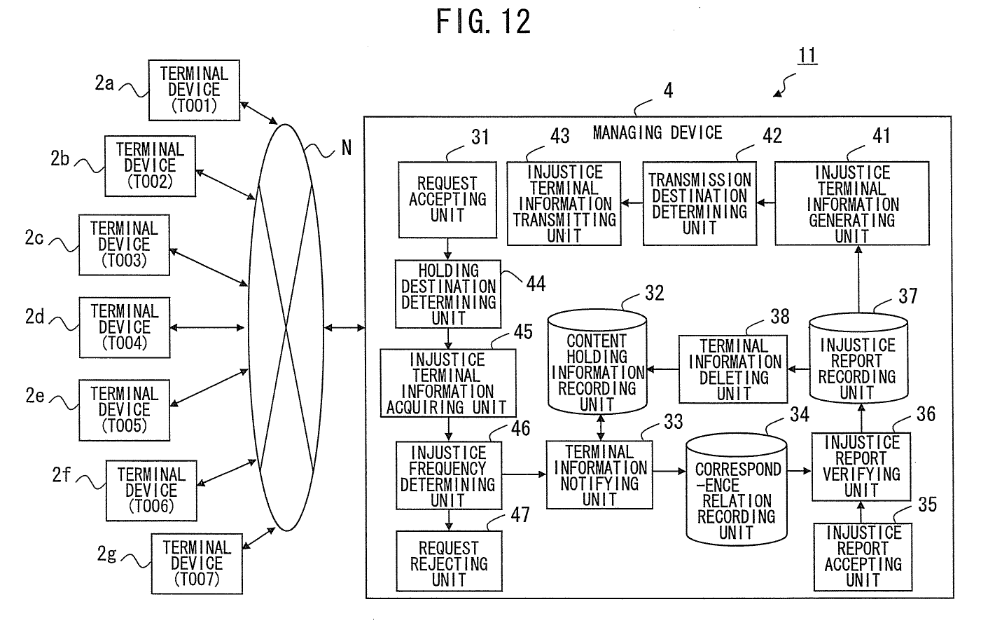

FIG. 12 illustrates the construction of a P2P system 11 according to this embodiment. That is, in the P2P system 11 according to this embodiment, the function of the managing device 4 is different from that of the managing device 3 illustrated in FIG. 1. In FIG. 12, the constructions having the same functions as illustrated in FIG. 1 are represented by the same reference numerals, and the detailed descriptions thereof are omitted.

(Construction of managing device 4 for transmitting injustice terminal information to terminal device 2) The managing device 4 has a function of generating injustice terminal information on the basis of an injustice report recorded in the injustice report recording unit 37, and transmitting the generated injustice terminal information to the terminal device 2. Therefore, the managing device 4 has an injustice terminal information generating unit 41, a transmission destination determining unit 42 and an injustice terminal information transmitting unit 43.

The injustice terminal information generating unit 41 generates injustice terminal information on the basis of the injustice report recorded in the injustice report recording unit 37.

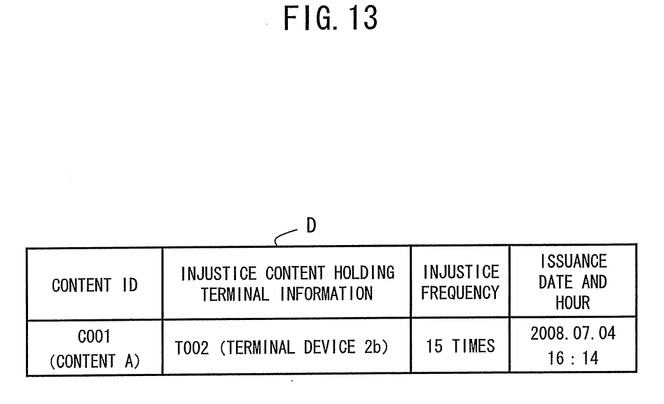

FIG. 13 illustrates an example of the data structure of injustice terminal information D generated by the injustice terminal information generating unit 41. As illustrated in FIG. 13, a content ID “C001”, injustice content holding terminal information “T002”, an injustice frequency “15 times”, and an issuance date and hour “2008, 07. 04 16:14” are contained in the injustice terminal information D.

Here, the injustice frequency according to this embodiment corresponds to the number of injustice records (the number of records) recorded in the injustice report recording unit 37. The issuance date and hour means the date and hour at which the injustice terminal information D is generated by the injustice terminal information generating unit 41. That is, in this embodiment, the issuance date and hour is “16:14 on Jul. 4, 2008”. The injustice terminal information generating unit 41 outputs the generated injustice terminal information to the transmission destination determining unit 42.

The timing at which the injustice terminal information generating unit 41 generates the injustice terminal information is not limited to a specific one.

For example, when it is monitored that the number of injustice reports recorded in the injustice report recording unit 37 is equal to a threshold value or more in the injustice report recording unit 37, the injustice terminal information generating unit 41 may generate injustice terminal information on the basis of the injustice reports recorded in the injustice report recording unit

Furthermore, for example when the content of the injustice report recording unit 37 is updated, the injustice terminal information generating unit 41 may generate the injustice terminal information on the basis of the injustice reports recorded in the injustice report recording unit 37.

On the basis of injustice content holding terminal information contained in injustice terminal information generated by the injustice terminal information generating unit 41, the transmission destination determining unit 42 determines a terminal device to which the injustice terminal information should be transmitted.

In this embodiment, the transmission destination determining unit 42 first adds a constant α to the injustice content holding terminal information “T002” contained in the injustice terminal information.

The transmission determining unit 42 applies the hash function to the injustice content holding terminal information “T002” added with the constant α to calculate the hash value.

The transmission destination determining unit 42 determines a terminal device having terminal information whose hash value is most approximate to the calculated hash value among the terminal devices 2a to 2g, as a terminal device to which the injustice terminal information should be transmitted.

The injustice content holding terminal information is added with the constant α and then the hash value is calculated because the terminal device to which the injustice terminal information should be transmitted is efficiently dispersed on the P2P system 11.

The injustice terminal information transmitting unit 43 transmits the injustice terminal information generated by the injustice terminal information generating unit 41 through the network N to the terminal device determined by the transmission destination determining unit 42.

The terminal device receives the injustice terminal information transmitted by the injustice terminal information transmitting unit 43 and records the received injustice terminal information into an internal memory. That is, the injustice terminal information generated by the injustice terminal information generating unit 41 can be dispersively recorded into plural terminal devices connected to the network N.

The construction of the managing device 4 for transmitting the injustice terminal information to the terminal device 2 is described above. For example, the injustice terminal information generating unit 41 may encipher the generated injustice terminal information by using a secret key of the managing device 4 to generate an electronic signature, and attach the generated electronic signature to the injustice terminal information.

In this case, the injustice terminal information transmitting unit 43 transmits the electronic-signature attached injustice terminal information to the terminal device determined by the transmission destination determining unit 42. Accordingly, by decoding the electronic signature with a public key of the managing device 4, it can be determined whether the terminal device receiving the injustice terminal information to which the electronic signature is attached is a rightful managing device 4 or not and the injustice terminal information is altered or not. Any well-known method is used as an electronic signature style, and it is not limited to a specific one.

(Construction of Managing Device 4 for Determining Whether Acquisition Request is Rejected or Not)

The managing device 4 has a function of determining whether the acquisition request of the content holding terminal information is rejected or not. Therefore, the managing device 4 further has a holding destination determining unit 44, an injustice terminal information acquiring unit 45, an injustice frequency determining unit 46 and a request rejecting unit 47.

When the request accepting unit 31 accepts an acquisition request of content holding terminal information, the holding destination determining unit 44 determines a terminal device holding the injustice terminal information of the terminal device transmitting the acquisition request on the basis of the terminal information (the request source terminal information) of the terminal device transmitting the acquisition request.

Here, in this embodiment, it is assumed that the request accepting unit 31 accepts the acquisition request of the content holding terminal information from the terminal device 2b. Therefore, the request source terminal information according to this embodiment is set to “T002”.

In this case, as in the case of the transmission destination determining unit 42 described above, the holding destination determining unit 44 first adds a constant α to the request source terminal information “T002”.

The holding destination determining unit 44 calculates the hash value by applying the hash function to the request source terminal information “T002” added with the constant α. Then, the holding destination determining unit 44 determines a terminal device having the terminal information whose hash value is most approximate to the calculated hash value among the terminal devices 2a to 2g, as the terminal device holding the injustice terminal information of the terminal device transmitting the acquisition request.

The injustice terminal information acquiring unit 45 acquires the injustice terminal information of the terminal device transmitting the acquisition request from the terminal device determined by the holding destination determining unit 44 through the network N. The injustice terminal information acquiring unit 45 outputs the acquired injustice terminal information to the injustice frequency determining unit 46.

The injustice frequency determining unit 46 determines whether the injustice frequency contained in the injustice terminal information acquired by the injustice terminal information acquiring unit 45 is equal to a threshold value or more. When it is determined that the injustice frequency is equal to the threshold value or more, the injustice frequency determining unit 46 instructs the request rejecting unit 47 to reject the acquisition request accepted by the request accepting unit 31.

On the other hand, when it is determined that the injustice frequency is less than the threshold value, the injustice frequency determining unit 46 instructs the terminal information notifying unit 33 to notify the content holding terminal information.

According to the instruction from the injustice frequency determining unit 46, the request rejecting unit 47 rejects the acquisition request accepted by the request accepting unit 31. In this case, the request rejecting unit 47 notifies the terminal device transmitting the acquisition request of the fact that the acquisition request is rejected. Accordingly, such a terminal device as transmits a content altered from the original content many times can be prevented from acquiring any content.

(Modification)

In the above-described embodiment, the injustice terminal information generated by the injustice terminal information generating unit 41 is transmitted to the terminal device determined by the transmission destination determining unit 42, and the injustice terminal information is acquired from the terminal device determined by the holding destination determining unit 44.

On the other hand, according to this modification, the injustice terminal information generated by the injustice terminal information generating unit is transmitted to a storage device connected to the network N, and the injustice terminal information is acquired from the storage device.

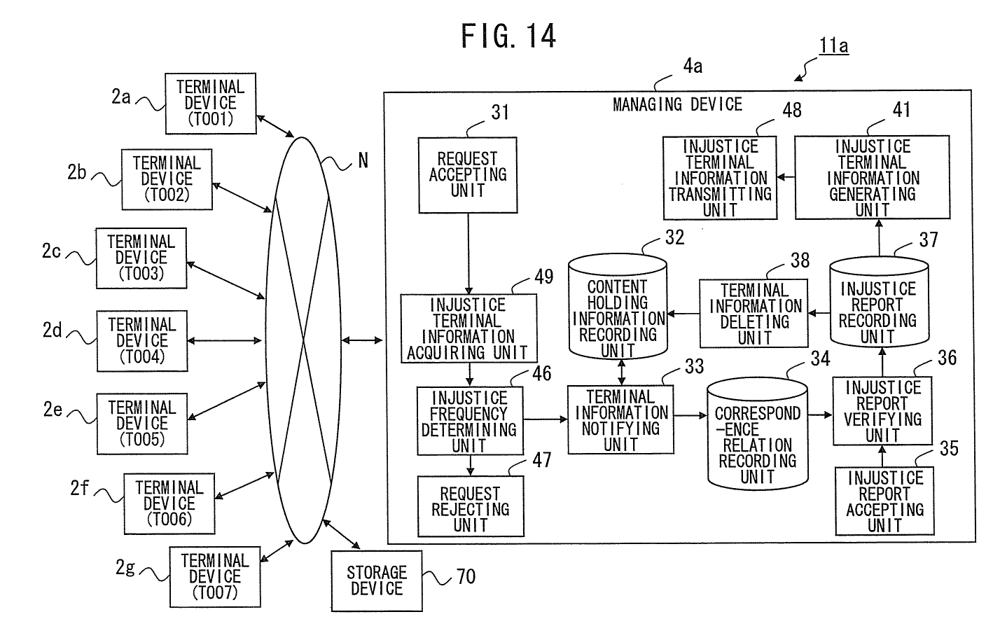

FIG. 14 illustrates the construction of the P2P system 11a according to this modification.

As illustrated in FIG. 14, a storage device 70 is further connected to the network N. The storage device 70 is constructed by one computer or plural computers such as a server machine, a personal computer, a work station or the like. The storage device 70 has a data base (not illustrated) therein.

Furthermore, in the P2P system 11a illustrated in FIG. 14, the function provided to the managing device 4a is different from that of the managing device 4 illustrated in FIG. 12. Specifically, the functions of the injustice terminal information transmitting unit 48 and the injustice terminal information acquiring unit 49 provided to the managing device 4a are different from the functions of the injustice terminal information transmitting unit 43 and the injustice terminal information acquiring unit 45 of the managing device 4. The managing device 4a illustrated in FIG. 14 is not provided with the transmission destination determining unit 42 and the holding destination determining unit 44 illustrated in FIG. 12.

The injustice terminal information transmitting unit 48 transmits the injustice terminal information generated by the injustice terminal information generating unit 41 to the storage device 70 through the network N. The storage device 70 receives the injustice terminal information transmitted by the injustice terminal information transmitting unit 48, and records the received injustice terminal information into an internal data base. Accordingly, the injustice terminal information generated by the injustice terminal information generating unit 41 can be collectively recorded into the storage device 70.

Furthermore, when the request accepting unit 31 accepts an acquiring request of content holding terminal information, the injustice terminal information acquiring unit 49 acquires the injustice terminal information of the terminal device transmitting the acquiring request from the storage device 70 through the network N.

That is, in this modification, the transmission destination determining unit 42 and the holding destination determining unit 44 do not calculate the hash values by using the hash function unlike the above-described embodiment, and thus the load of the managing device 4a can be reduced as compared with the managing device 4 illustrated in FIG. 12.

Still furthermore, the injustice terminal information is collectively recorded into the storage device 70, and thus the injustice terminal information can be easily managed.

In this modification, the injustice terminal information generating unit 41 also may encipher the generated injustice terminal information by using a secret key of the managing device 4a to generate an electronic signature, and attach the generated electronic signature to the injustice terminal information.

In this case, the injustice terminal information transmitting unit 48 transmits the electronic signature attached injustice terminal information to the storage device 70. Accordingly, the storage device 70 decodes the electronic signature by a public key of the managing device 4a to determine whether the managing device 4a is a rightful managing device 4a or not and the injustice terminal information is altered or not.

(Example of Operation of P2P System 11)

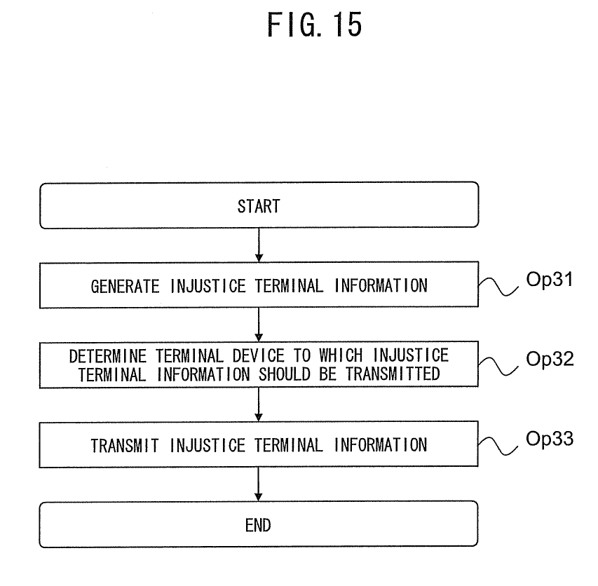

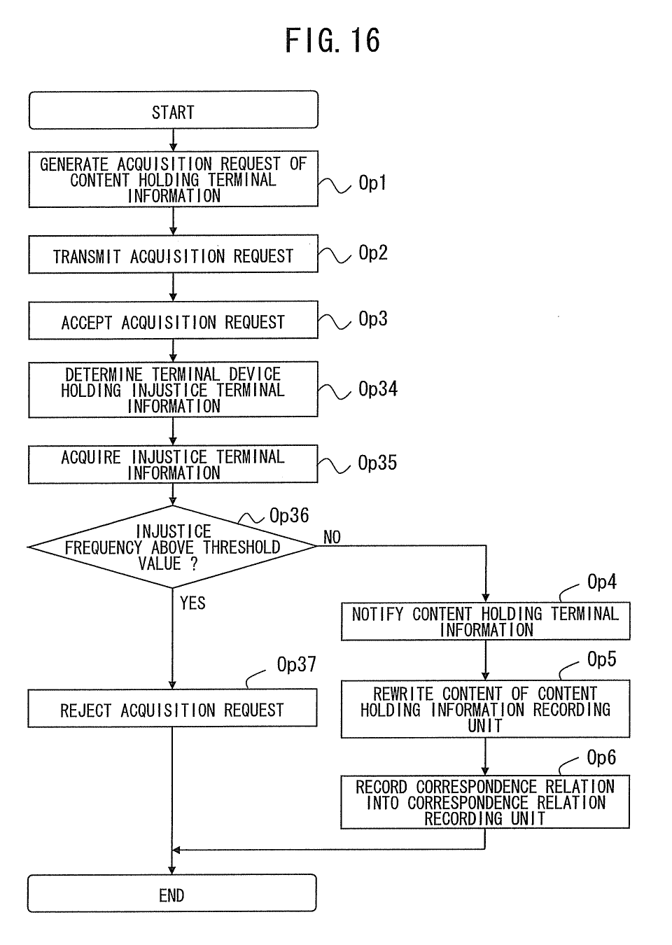

Next, the operation of the thus-constructed P2P system 11 will be described with reference to FIGS. 15 and 16.

FIG. 15 illustrates an example of the operation of the P2P system 11 when the managing device 4 generates the injustice terminal information.

As illustrated in FIG. 15, the injustice terminal information generating unit 41 of the managing device 4 generates the injustice terminal information on the basis of the injustice report recorded in the injustice report recording unit 37 (Op31).

On the basis of injustice content holding terminal information contained in the injustice terminal information generated in Op31, the transmission destination determining unit 42 determines a terminal device to which the injustice terminal information should be transmitted (Op32).

The injustice terminal information transmitting unit 43 transmits the injustice terminal information generated in Op31 through the network N to the terminal device determined in Op32 (Op33)

FIG. 16 illustrates an example of the operation of the P2P system 11 when the terminal device 2 transmits an acquisition request to the managing device 4. In FIG. 16, parts representing the same operations as illustrated in FIG. 9 are represented by the same reference numerals, and the detailed description thereof is omitted.

After Op3, the holding destination determining unit 44 determines a terminal device holding the injustice terminal information of the terminal device transmitting the acquisition request accepted in Op3 on the basis of the terminal information (request source terminal information) of the terminal device transmitting the acquisition request (Op34).

The injustice terminal information acquiring unit 45 acquires the injustice terminal information of the terminal device transmitting the acquisition request from the terminal device determined in Op34 through the network N (Op35).

The injustice frequency determining unit 46 determines whether the injustice frequency contained in the injustice terminal information acquired in Op35 is equal to a threshold value or more (Op36).

When it is determined that the injustice frequency is equal to the threshold value or more (YES in Op36), the injustice frequency determining unit 46 instructs the request rejecting unit 47 to reject the acquisition request accepted by the request accepting unit 31. In this case, the request rejecting unit 47 rejects the acquisition request accepted in Op3 according to the instruction from the injustice frequency determining unit 46 (Op37).

On the other hand, when it is determined that the injustice frequency is less than the threshold value (NO in Op36), the injustice frequency determining unit 46 instructs the terminal information notifying unit 33 to notify content holding terminal information. In this case, the terminal information notifying unit 33 notifies the content holding terminal information to the terminal device 2 transmitting the acquisition request (Op4).

As described above, according to the managing device 4 of this embodiment, such a terminal device as transmits a content altered from the original content many times can be prevented from acquiring any content.

### Embodiment 3

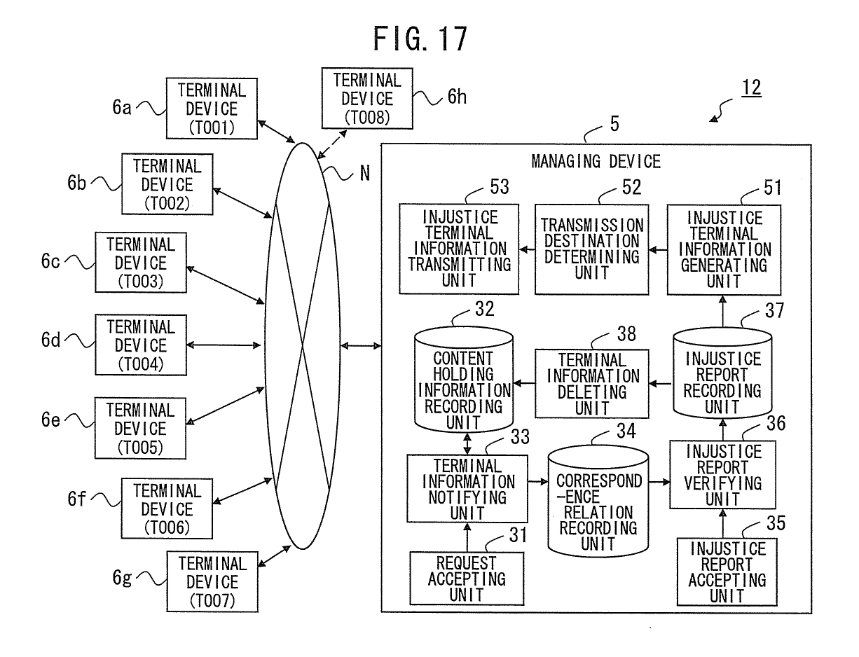

FIG. 17 illustrates the construction of a P2P system 12 according to this embodiment.

That is, in the P2P system 12 according to this embodiment, the functions of the managing device 5 and the terminal devices 6a to 6g are different from those of the managing device 3 and the terminal devices 2a to 2g illustrated in FIG. 1. In FIG. 17, the constructions having the same functions as illustrated in FIG. 1 are represented by the same reference numerals, and the detailed description thereof is omitted.

Here, in this embodiment, the terminal information for identifying the terminal device 6a is set to “T001” as illustrated in FIG. 17. Likewise, the terminal information for identifying the terminal devices 6b to 6g are set to “T002” to “T007”, respectively.

(Construction of Managing Device 5)

As in the case of the managing device 4 illustrated in FIG. 12, the managing device 5 has a function of generating injustice terminal information on the basis of an injustice report recorded in the injustice report recording unit 37 and transmitting the generated injustice terminal information to the terminal device 2. Therefore, the managing device 5 has an injustice terminal information generating unit 51, a transmission destination determining unit 52 and an injustice terminal information transmitting unit 53.

The functions of the injustice terminal information generating unit 51, the transmission destination determining unit 52 and the injustice terminal information transmitting unit 53 illustrated in FIG. 17 are similar to the functions of the injustice terminal information generating unit 41, the transmission destination determining unit 42 and the injustice terminal information transmitting unit 43 illustrated in FIG. 12, respectively.

Furthermore, the managing device 5 may be provided with the holding destination determining unit 44, the injustice terminal information acquiring unit 45, the injustice frequency determining unit 46 and the request rejecting unit 47 illustrated in FIG. 12.

(Construction of Terminal Device 6)

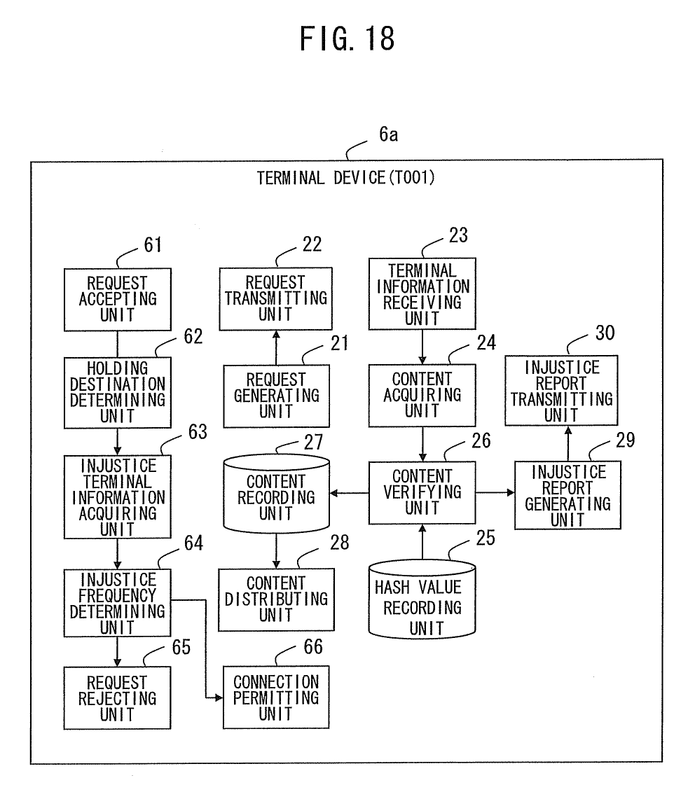

FIG. 18 illustrates the construction of a terminal device 6a according to this embodiment. The constructions of the terminal devices 6b to 6g are similar to the construction of the terminal device 6a.

Here, the terminal device 6a has a function of determining whether a request for connecting to the network N (hereinafter referred to as “connection request to network N”) is rejected or not. Therefore, in addition to the configuration of the terminal device 2 illustrated in FIG. 2, the terminal device 6 is further provided with a request accepting unit 61, a holding destination determining unit 62, an injustice terminal information acquiring unit 63, an injustice frequency determining unit 64, a request rejecting unit 65 and a connection permitting unit 66.

The request accepting unit 61 accepts the connection request to the network N from a terminal device (for example, a terminal device 6h) other than the terminal devices 6a to 6g connected to the network N. The request accepting unit 61 outputs to the holding destination determining unit 62 the accepted connection request to the network N.

When the request accepting unit 61 accepts the connection request to the network N, the holding destination determining unit 62 determines the terminal device holding the injustice terminal information of the terminal device transmitting the connection request on the basis of the terminal information (the request source terminal information) of the terminal device transmitting the connection request.

Here, in this embodiment, it is assumed as illustrated in FIG. 17 that the request accepting unit 61 accepts the connection request to the network N from the terminal device 2h which wishes to participate in the network N. Therefore, the request source terminal information according to this embodiment is set to “T008”. In this case, the holding destination determining unit 62 first adds the request source terminal information “T008” with a constant α. The holding destination determining unit 62 applies the hash function to the request source terminal information “T008” added with the constant α to calculate the hash value. Then, the holding destination determining unit 62 determines a terminal device having terminal information whose hash value is most approximate to the calculated hash value among the terminal devices 6a to 6g, as a terminal device holding the injustice terminal information of the terminal device transmitting the connection request.

The injustice terminal information acquiring unit 63 acquires the injustice terminal information of the terminal device transmitting the connection request from the terminal device determined by the holding destination determining unit 62 through the network N. The injustice terminal information acquiring unit 63 outputs the acquired injustice terminal information to the injustice frequency determining unit 64.

The injustice frequency determining unit 64 determines whether the injustice frequency contained in the injustice terminal information acquired by the injustice terminal information acquiring unit 63 is equal to a threshold value or more.

When it is determined that the injustice frequency is equal to the threshold value or more, the injustice frequency determining unit 64 instructs the request rejecting unit 65 to reject the connection request accepted by the request accepting unit 61.

On the other hand, when it is determined that the injustice frequency is less than the threshold value, the injustice frequency determining unit 64 instructs the connection permitting unit 66 to permit the connection request accepted by the request accepting unit 61.

The request rejecting unit 65 rejects the connection request accepted by the request accepting unit 61 according to the instruction from the injustice frequency determining unit 64. In this case, the request rejecting unit 65 notifies the terminal device 6h of the fact that the connection request is rejected. Accordingly, the connection request to the network N can be rejected to such a terminal device as transmits a content altered from the original content many times.

The connection permitting unit 66 permits the connection request accepted by the request accepting unit 61 according to the instruction from the injustice frequency determining unit 64. Accordingly, the terminal device 6h can participate in the network N.

(Example of Operation of P2P System 12)

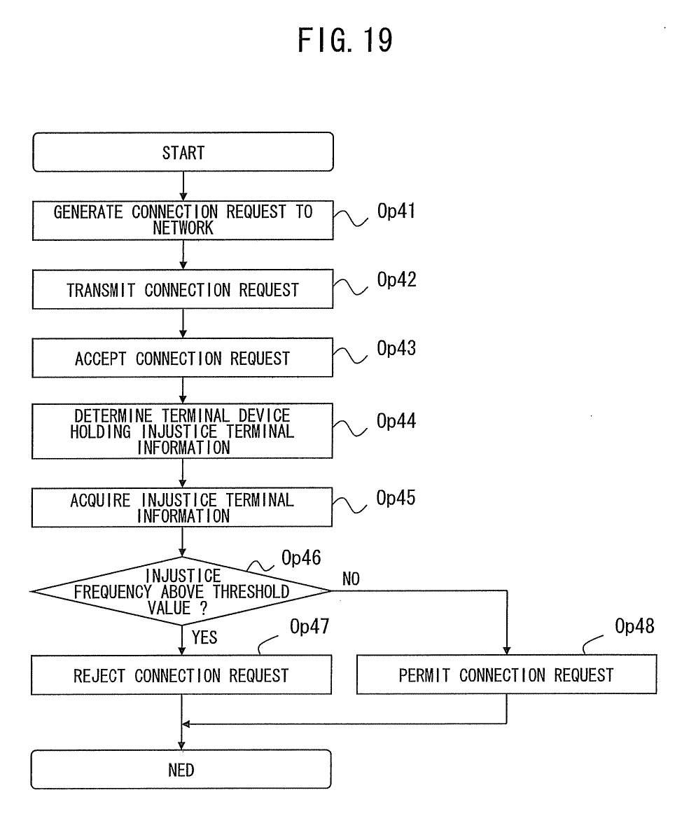

Next, the operation of the thus-constructed P2P system 12 will be described with reference to FIG. 19.

FIG. 19 illustrates an example of the operation of the P2P system 12 when a terminal device which wishes to connect to the network N transmits a request for connection to the network N to a terminal device 6 connected to the network N.

As illustrated in FIG. 19, the terminal device which wishes the connection to the network N generates a connection request to the network N (Op41). The terminal device transmits the connection request generated in Op41 to the terminal device 6 through the network N (Op42).

Subsequently, the request accepting unit 61 of the terminal device 6 accepts the connection request transmitted in Op42 (Op43).

The terminal device holding the injustice terminal information of the terminal device which transmits the connection request accepted in Op43 is determined on the basis of the terminal information (request source terminal information) of the terminal device transmitting the connection request by the holding destination determining unit 62 (Op44). Then, the injustice terminal information acquiring unit 63 acquires the injustice terminal information of the terminal device transmitting the connection request from the terminal device determined in Op44 through the network N (Op45).

The injustice frequency determining unit 64 determines whether the injustice frequency contained in the injustice terminal information acquired in Op45 is equal to a threshold value or more (Op46).

When it is determined that the injustice frequency is equal to the threshold value or more (YES in Op46), the injustice frequency determining unit 64 instructs the request rejecting unit 65 to reject the connection request accepted by the request accepting unit 61. In this case, the request rejecting unit 65 rejects the connection request accepted in Op43 according to the instruction from the injustice frequency determining unit 64 (Op47).

On the other hand, when it is determined that the injustice frequency is less than the threshold value (NO in Op46), the injustice frequency determining unit 64 instructs the connection permitting unit 66 to permit the connection request accepted in Op43. In this case, the connection permitting unit 66 permits the connection request accepted in Op43 according to the instruction from the injustice frequency determining unit 64 (Op48).

As described above, according to the terminal device 6 of this embodiment, the connection request to the network N can be rejected to such a terminal device as transmits a content altered from the original content many times.

In the embodiment 3, the injustice terminal information generated by the injustice terminal information generating unit 51 is transmitted to the terminal device determined by the transmission destination determining unit 52, and the injustice terminal information is acquired from the terminal device determined by the holding destination determining unit 62. However, the present invention is not limited to this style.

For example, as described with reference to the modification of the embodiment 2, the storage device connected to the network N may be newly provided on the P2P system 12 illustrated in FIG. 17, whereby the injustice terminal information generated by the injustice terminal information generating unit is transmitted to the storage device and the injustice terminal information is acquired from the storage device.

Furthermore, in the embodiments 1 to 3, the terminal device which wishes to acquire a content verifies whether a content acquired by the content acquiring unit is a content altered from the original content or not. However, the present invention is not limited to this style.

For example, when the content acquiring request is accepted, it maybe verified in the terminal device holding the content whether the content is a content altered from the original content.

Furthermore, in the embodiments 1 to 3, each recording unit records each information as a table. However, the present invention is not limited to this style. That is, the style of recording each information into each recording unit is not limited to the table style, and any style may be used.

That is, the present invention is not limited to the embodiments 1 to 3, and various modifications described in “Claims” can be made. That is, embodiments obtained by combining the technical means which are properly altered in the scope of the claims may be contained in the technical scope of the present invention.

Therefore, according to an aspect of the embodiments of the invention, any combinations of the described features, functions, operations, and/or benefits can be provided. The embodiments can be implemented as an apparatus (a machine) that includes computing hardware (i.e., computing apparatus), such as (in a non-limiting example) any computer that can store, retrieve, process and/or output data and/or communicate (network) with other computers. According to an aspect of an embodiment, the described features, functions, operations, and/or benefits can be implemented by and/or use computing hardware and/or software. The apparatus (e.g., the terminal devices 2, the managing device 3, etc.) comprises a controller (CPU) (e.g., a hardware logic circuitry based computer processor that processes or executes instructions, namely software/program), computer readable recording media, transmission communication media interface (network interface), and/or a display device, all in communication through a data communication bus. The results produced can be displayed on the display. A program/software implementing the embodiments may be recorded on computer-readable recording media. Examples of the computer-readable recording media include a magnetic recording apparatus, an optical disk, a magneto-optical disk, and/or volatile and/or non-volatile semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), DVD-ROM, DVD-RAM (DVD-Random Access Memory), BD (Blue-ray Disk), a CD-ROM (Compact Disc-Read Only Memory), and a CD-R (Recordable)/RW.

The program/software implementing the embodiments may also be included/encoded as a data signal and transmitted over transmission communication media. A data signal moves on transmission communication media, such as the wired network or the wireless network, for example, by being incorporated in a carrier wave. However, the data signal may be transferred not by the carrier wave described above but as a so-called baseband signal. Such a carrier wave is transmitted in an electrical, magnetic or electromagnetic form, or an optical, acoustic or any other form.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. An information processing managing device operable to access a network to which a plurality of terminal devices are connected, comprising:
a content holding information recording unit for recording content holding terminal information identifying a terminal device holding a content from the plurality of terminal devices;
a request accepting unit for accepting an acquisition request of the content holding terminal information from a requesting terminal device;
a terminal information notifying unit for notifying the content holding terminal information to the requesting terminal device transmitting the acquisition request, according to the acquisition request accepted by the request accepting unit;
a correspondence relation recording unit associating notification destination terminal information identifying the requesting terminal device to which the content holding terminal information is notified by the terminal information notifying unit with content holding terminal information notified to the requesting terminal device by the terminal information notifying unit; and
a grievance report accepting unit for accepting grievance report indicating that a content acquired according to the content holding terminal information notified by the terminal information notifying unit is a content altered from an original content,
wherein the grievance report contains grievance report source terminal information for identifying a terminal device transmitting the grievance report and grievance content holding terminal information identifying a terminal device holding the content altered from the original content,
wherein the information processing device further comprises a grievance report verifying unit for determining that the grievance report accepted by the grievance report accepting unit is a false grievance report and discarding the false grievance report accepted by the grievance report accepting unit, when the grievance report source terminal information contained in the grievance report is not coincident with the notification destination terminal information recorded in the correspondence relation recording unit, or when the grievance report source terminal information contained in the grievance report is coincident with the notification destination terminal information recorded in the correspondence relation recording unit and grievance content holding terminal information contained in the grievance report is not coincident with the content holding terminal information recorded in association with the notification destination terminal information in the correspondence relation recording unit.

2. The information processing device according to claim 1,
wherein the grievance report verifying unit determines that a grievance report accepted by the grievance report accepting unit is valid and records the valid grievance report into a grievance report recording unit, when the grievance report source terminal information contained in the grievance report is coincident with the notification destination terminal information recorded in the correspondence relation recording unit and the grievance content holding terminal information contained in the grievance report is coincident with the content holding terminal information which is recorded in association with the notification destination terminal information in the correspondence relation recording unit, and
wherein the grievance report verifying unit further comprises a terminal information deleting unit for deleting, from the content holding information recording unit, same content holding terminal information as the grievance content holding terminal information contained in the valid grievance report when a number of grievance reports recorded in the grievance report recording unit for the grievance content holding terminal information contained in the valid grievance is equal to or greater than a threshold value.

3. The information processing device according to claim 2, further comprising:
a grievance terminal information generating unit for generating, based upon a grievance report recorded in the grievance report recording unit, and grievance terminal information containing grievance content holding terminal information contained in the grievance report and a grievance frequency representing a number of grievance reports recorded in the grievance report recording unit for the grievance content holding terminal information;
a transmission destination determining unit for determining, based upon grievance content holding terminal information contained in the grievance terminal information, a terminal device to which the generated grievance terminal information should be transmitted; and
a grievance terminal information transmitting unit for transmitting the generated grievance terminal information to the determined transmission destination terminal.

4. The information processing device according to claim 3,
wherein the grievance terminal information generating unit attaches an electronic signature to generated grievance terminal information by using a secret key of the managing device, and the grievance terminal information transmitting unit transmits the electronic-signature attached grievance terminal information to the determined destination terminal device.

5. The information processing device according to claim 2, further comprising a holding destination determining unit for determining a terminal device for holding grievance terminal information of a terminal device transmitting a request for acquiring content holding terminal information, based upon request source terminal information identifying the terminal device transmitting the acquisition request when the request accepting unit accepts the acquisition request;
an grievance terminal information acquiring unit for acquiring the grievance terminal information of the terminal device transmitting the acquisition request, from the terminal device determined by the holding destination determining unit; and
a request rejecting unit for rejecting the acquisition request accepted by the request accepting unit when a number of grievances contained in the grievance terminal information acquired by the grievance terminal information acquiring unit is equal to or greater than a threshold value.

6. The information processing device according to claim 1, further comprising: a request accepting unit for accepting a connection request to the network from a terminal device;
a holding determining unit for determining, when the request accepting unit accepts the connection request to the network, a terminal device that is to acquire grievance terminal information of the terminal device transmitting the connection request on the basis of request source terminal information for identifying the terminal device which transmits the connection request;
an grievance terminal information acquiring unit for acquiring the grievance terminal information of the terminal device transmitting the connection request from the terminal device determined by the holding destination determining unit; and
a request rejecting unit for rejecting the connection request accepted by the request accepting unit when the number of grievances contained in the grievance terminal information acquired by the grievance terminal information acquiring unit is equal to or more than a threshold value.

7. The information processing device according to claim 2, further comprising:
a grievance terminal information generating unit for generating, based upon a grievance report recorded in the grievance report recording unit, grievance terminal information containing grievance content holding terminal information contained in the grievance report and a grievance frequency representing a number of grievance reports recorded in the grievance report recording unit for the grievance content holding terminal information; and
a grievance terminal information transmitting unit for transmitting the grievance terminal information generated by the grievance terminal information generating unit to a storage device.

8. The information processing device according to claim 7,
wherein the grievance terminal information generating unit attaches an electronic signature to the generated grievance terminal information by using a secret key of the managing device, and the grievance terminal information transmitting unit transmits the electronic-signature attached grievance terminal information to the storage device.

9. The information processing device according to claim 7, further comprising:
a grievance terminal information acquiring unit for acquiring, from the storage device, grievance terminal information of a terminal device transmitting an acquisition request of content holding terminal information, when the request accepting unit accepts the acquisition request of the content holding terminal information; and
a request rejecting unit for rejecting the acquisition request accepted by the request accepting unit when a grievance frequency contained in the grievance terminal information acquired by the grievance terminal information acquiring unit is equal to or more than a threshold value.

10. A method of managing access to content of a plurality of terminal devices connected by a network, the method comprising:
received an acquisition request of a content holding terminal information from a requesting terminal device;
acquiring the content holding terminal information from recorded content holding terminal information identifying a terminal device holding a target content;
notifying the content holding terminal information to the requesting terminal device transmitting the acquisition request according to the received acquisition request;
receiving a grievance report containing grievance report source terminal information identifying a terminal device transmitting the grievance report and grievance content holding terminal information identifying a terminal device holding content altered from the target content and content identification information for identifying the altered content;
associating notification destination terminal information identifying the requesting terminal device to which the content holding terminal information is notified with content holding terminal information notified to the requesting terminal device with content identification information identifying the target content;
acquiring, based upon the associating, the notification destination terminal information or the content holding terminal information corresponding to content identification information contained in a grievance report; and
determining that the grievance report is false and discarding the false grievance report, when according to the associating the grievance report source terminal information contained in the grievance report is not coincident with the notification destination terminal information, or when the grievance report source terminal information contained in the grievance report is coincident with the notification destination terminal information and grievance content holding terminal information contained in the grievance report is not coincident with the content holding terminal information.

11. A computer-readable medium comprising a computer-executable instructions that causes a computer, which is operable to access to a network to which a plurality of terminal devices are connected, to execute:
receiving an acquisition request of a content holding terminal information from a requesting terminal device;
acquiring the content holding terminal information from recorded content holding terminal information identifying a terminal device holding a target content;
notifying the content holding terminal information to the requesting terminal device transmitting the acquisition request according to the received acquisition request;
receiving a grievance report containing grievance report source terminal information identifying a terminal device transmitting the grievance report and grievance content holding terminal information identifying a terminal device holding content altered from the target content and content identification information for identifying the altered content;
associating notification destination terminal information identifying the requesting terminal device to which the content holding terminal information is notified with content holding terminal information notified to the requesting terminal device with content identification information identifying the target content,;
acquiring, based upon the associating, the notification destination terminal information or the content holding terminal information corresponding to content identification information contained in a grievance report; and
determining that the grievance report is false and discarding the false grievance report, when according to the associating the grievance report source terminal information contained in the grievance report is not coincident with the notification destination terminal information, or when the grievance report source terminal information contained in the grievance report is coincident with the notification destination terminal information and grievance content holding terminal information contained in the grievance report is not coincident with the content holding terminal information.

12. A communication system having a plurality of terminal devices and a managing device connected to a network, the managing device comprising:
a computer readable recording medium recording content holding terminal information to identify a terminal device holding a content from the plurality of terminal devices; and
a computer processor executing
receiving an acquisition request of the content holding terminal information from a requesting terminal device; and
notifying the content holding terminal information to the requesting terminal device transmitting the acquisition request according to the received acquisition request;
associating notification destination terminal information identifying requesting terminal device to which the content holding terminal information is notified with content holding terminal information notified to the requesting terminal device;
receiving a grievance report indicating that a content acquired according to the notified content holding terminal information is a content altered from an original content,
wherein the grievance report contains grievance report source terminal information identifying a terminal device transmitting the grievance report and grievance content holding terminal information identifying a terminal device holding the content altered from the original content; and
verifying the grievance report by determining whether the received grievance report is false and discarding the received grievance report when based upon the associating the grievance report source terminal information contained in the grievance report is not coincident with the notification destination terminal information, or when the grievance report source terminal information contained in the grievance report is coincident with the notification destination terminal information and grievance content holding terminal information contained in the grievance report is not coincident with the content holding terminal information.
